(19) United States
(12) Patent Application Publication
(10) Pub. No.: US 2009/0194344 A1
(43) Pub. Date: Aug. 6, 2009

(54) Single Layer Mutual Capacitance Sensing Systems, Device, Components and Methods

(75) Inventors: Jonah A. Harley, Mountain View, CA (US); Timothy J. Orsley, San Jose, CA (US)

Correspondence Address: Kathy Manke;Avago Technologies Limited, 4380 Ziegler Road, Fort Collins, CO, 80525, US

(73) Assignee: Avago Technologies ECBU IP (Singapore) Pte. Ltd., Singapore (SG)

(21) Appl. No.: 12/024,057

(22) Filed: Jan. 31, 2008

(51) Int. Cl. G06F 3/044

(52) U.S. Cl. 178/18.06

(57) ABSTRACT

According to one embodiment, there is provided a mutual capacitance sensing system comprising at least one substrate comprising an electrode array mounting surface. A plurality of drive electrodes are disposed in a first plurality of rows or columns positioned upon the electrode array mounting surface, where the drive electrodes in each row or column are electrically connected to one another. A plurality of sense electrodes are disposed in a second plurality of rows or columns positioned upon the electrode array mounting surface that is substantially perpendicular to the first plurality of rows or columns, and the sense electrodes in each column are electrically connected to one another. The sense and drive electrodes form an array disposed substantially in a single plane that is configured to permit at least one location corresponding to at least one finger placed in proximity thereto to be detected thereby.

### FIELD OF THE INVENTION

Various embodiments of the invention described herein relate to the field of capacitive sensing input devices generally, and more specifically to mutual capacitance measurement or sensing systems, devices, components and methods finding particularly efficacious applications in touchscreen and touchpad devices. Embodiments of the invention described herein include those amenable for use in portable or hand-held devices such cell phones, MP3 players, personal computers, game controllers, laptop computers, PDA's and the like. Also described are embodiments adapted for use in stationary applications such as in industrial controls, washing machines, exercise equipment, and the like.

### BACKGROUND

Two principal capacitive sensing and measurement technologies are currently employed in most touchpad and touchscreen devices. The first such technology is that of self-capacitance. Many devices manufactured by SYNAPTICS™ employ self-capacitance measurement techniques, as do integrated circuit (IC) devices such as the CYPRESS PSOC.™ Self-capacitance involves measuring the self-capacitance of a series of electrode pads using techniques such as those described in U.S. Pat. No. 5,543,588 to Bisset et al. entitled “Touch Pad Driven Handheld Computing Device” dated Aug. 6, 1996.

Self-capacitance is a measure of how much charge has accumulated on an object held at a given voltage (Q=CV). Self-capacitance is typically measured by applying a known voltage to an electrode, and then using a circuit to measure how much charge flows to that same electrode. When external grounded objects are brought close to the electrode, additional charge is attracted to the electrode. As a result, the self-capacitance of the electrode increases. Many touch sensors are configured such that the external grounded object is a finger. The human body is essentially a capacitor to ground, typically with a capacitance of around 100 pF.

Electrodes in self-capacitance touchpads are typically arranged in rows and columns. By scanning first rows and then columns the locations of individual disturbances induced by the presence of a finger, for example, can be determined. To effect accurate multi-touch measurements in a touchpad, however, it may be required that several finger touches be measured simultaneously. In such a case, row and column techniques for self-capacitance measurement can lead to inconclusive results, as illustrated in FIG. 1. If two fingers simultaneously touch the positions labelled “A” in FIG. 1, strong signals are detected when columns 22 and 26 are scanned. Strong signals are also detected between rows 42 and 43, and between rows 44 and 45. Unfortunately, fingers placed at the positions labelled “B” in FIG. 1 produce the same output signals as those produced by fingers placed at positions “A” in FIG. 1. As a result, the touchpad sensing system illustrated in FIG. 1 suffers from a fundamental ambiguity respecting the actual positions of multiple objects placed simultaneously on or near the touchscreen.

One method of overcoming the foregoing problems in self-capacitance systems is to provide a system that does not employ a row and column scanning scheme, and that is instead configured to measure each touchpad electrode individually. Such a system is described in U.S. Patent Publication No. 2006/097991 to Hotelling et al. entitled “Multipoint touchscreen” dated May 11, 2006. In the touchpad sensing system disclosed in the foregoing patent publication to Hotelling, each electrode is connected to a pin of an integrated circuit (“IC”), either directly to a sense IC or via a multiplexer. As will become clear to those skilled in the art, however, individually wiring electrodes in such a system can add considerable cost to a self-capacitance system. For example, in an n×n grid of electrodes, the number of IC pins required is n². (The APPLE™ IPOD™ employs a similar capacitance measurement system.)

One way in which the number of electrodes can be reduced in a self-capacitance system is by interleaving the electrodes in a saw-tooth pattern. Such interleaving creates a larger region where a finger is sensed by two adjacent electrodes allowing better interpolation, and therefore fewer electrodes. Such patterns can be particularly effective in one dimensional sensors, such as those employed in IPOD click-wheels. See, for example, U.S. Pat. No. 6,879,930 to Sinclair et al. entitled Capacitance touch slider dated Apr. 12, 2005.

The second primary capacitive sensing and measurement technology employed in touchpad and touchscreen devices is that of mutual capacitance, where measurements are performed using a crossed grid of electrodes, such as that illustrated in FIG. 2. See also, for example, U.S. Pat. No. 5,861,875 to Gerpheide entitled “Methods and Apparatus for Data Input” dated Jan. 19, 1999. Mutual capacitance technology is employed in touchpad devices manufactured by CIRQUE.™ In mutual capacitance measurement, capacitance is measured between two conductors, as opposed to a self-capacitance measurement in which the capacitance of a single conductor is measured, and which may be affected by other objects in proximity thereto.

In the mutual capacitance measurement system illustrated in FIG. 2, where an array of sense electrodes is disposed on a first side of a substrate and an array of drive electrodes is disposed on a second side of the substrate that opposes the first side, a column or row of electrodes in the drive electrode array is driven to a particular voltage, the mutual capacitance to a single row (or column) of the sense electrode array is measured, and the capacitance at a single row-column intersection is determined. By scanning all the rows and columns a map of capacitance measurements may be created for all the nodes in the grid. When a user's finger approaches a given grid point, some of the electric field lines emanating from or near the grid point are deflected, thereby decreasing the mutual capacitance of the two electrodes at the grid point. Because each measurement probes only a single grid intersection point, no measurement ambiguities arise with multiple touches as in the case of some self-capacitance systems. Moreover, to measure a grid of n×n intersections, only 2n pins on an IC are needed in a system of the type shown in FIG. 2.

Despite the advantages of a mutual capacitance measurement system, however, such a mutual capacitance grid arrangement is generally better suited to touchpad applications than touchscreen applications. In many touchscreen designs, for example, each of the rows and columns of electrodes requires its own layer of indium tin oxide (ITO). Using stacked layers of ITO can result in an excessive amount of light being absorbed by, or otherwise not transmitted through, a display, which decreases display brightness. In addition, with volume at such a premium in small handheld devices, anything that can be done to decrease the footprint, volume or thickness of a device is helpful. The multiple electrode layers required in current mutual capacitance systems undesirably add to device volume. In addition, because sense and drive electrodes are configured in separate layers separated by an insulating layer, the electric field established between the sense and drive electrodes, and that is employed to effect capacitive touch sensing, must penetrate the thickness of the insulating layer between the electrode layers. Such an electrode configuration diminishes touch sensitivity, as some portion of the electric field is used merely to penetrate the insulating layer.

What is needed is a capacitive measurement system that may be employed in touchscreen and touchpad applications that is capable of accurately and consistently discriminating between multiple touches, highly responsive and sensitive, does not absorb or otherwise excessively impede the transmission of light therethrough, and that has a smaller footprint, volume or thickness.

Further details concerning various aspects of some prior art devices and methods are set forth in: (1) U.S. Pat. No. 4,550,221 to Mabusth entitled “Touch Sensitive Control Device” dated Oct. 29, 1985; (2) U.S. Pat. No. 5,305,017 to Gerpheide entitled “Methods and Apparatus for Data Input” dated Apr. 19, 1994, and (3) U.S. Pat. No. 5,844,506 to Binstead entitled “Multiple Input Proximity Detector and Touchpad System” dated Dec. 1, 1998.

### SUMMARY

In one embodiment, there is a provided a mutual capacitance sensing system comprising at least one substrate comprising an outer touch surface and an inner surface disposed substantially in a single plane, the outer touch and inner surfaces forming opposing substantially planar and substantially parallel surfaces, a plurality of drive electrodes disposed in a first plurality of rows or columns positioned upon the inner surface substantially in the single plane, the drive electrodes in each row or column being electrically connected to one another, a plurality of sense electrodes disposed in a second plurality of rows or columns also positioned upon the inner surface substantially in the single plane, the sense electrodes in each column being electrically connected to one another, wherein the first plurality of rows or columns is substantially perpendicular to the second plurality of rows or columns, the outer touch surface is configured for a user to place at least one finger thereon and move the at least one finger thereacross, and the drive and sense electrodes form an array configured in respect of the outer touch surface to permit at least one location corresponding to the at least one finger on the outer touch surface to be detected by the array.

In another embodiment, there is provided a mutual capacitance sensing system comprising at least one substrate comprising an electrode array mounting surface disposed substantially in the single plane, a plurality of drive electrodes disposed in a first plurality of rows or columns positioned upon the electrode array mounting surface substantially in the single plane, the drive electrodes in each row being electrically connected to one another, a plurality of sense electrodes disposed in a second plurality of rows or columns positioned upon the electrode array mounting surface substantially in the single plane, the sense electrodes in each column being electrically connected to one another, wherein the first plurality of rows or columns is substantially perpendicular to the second plurality of rows or columns, and the drive and sense electrodes form an array configured to permit at least one location corresponding to at least one finger placed in proximity to the electrode array mounting surface to be detected by the array.

In yet another embodiment, there is provided a method of making a mutual capacitance sensing system comprising providing at least one substrate comprising an outer touch surface and an inner surface disposed in a single plane, the outer touch and inner surfaces forming opposing substantially planar and substantially parallel surfaces, disposing a plurality of drive electrodes in a first plurality of rows or columns upon the inner surface substantially in the single plane, and electrically connecting the drive electrodes in each row or column to one another, and disposing a plurality of sense electrodes in a second plurality of rows or columns upon the inner surface substantially in the single plane and electrically connecting the sense electrodes in each row or column, the second plurality of rows or columns being substantially perpendicular to the first plurality of rows or columns, wherein the drive and sense electrodes form an array that is configured to permit at least one location corresponding to at least one finger placed on the outer touch surface to be detected by the array.

In still another embodiment, there is provided a method of making a mutual capacitance sensing system comprising providing at least one substrate comprising an electrode array mounting surface disposed in a single plane, disposing a plurality of drive electrodes in a first plurality of rows or columns upon the electrode array mounting surface substantially in the single plane, and electrically connecting the drive electrodes in each row or column to one another, disposing a plurality of sense electrodes in a second plurality of rows or columns upon the electrode array mounting surface substantially in the single plane, and electrically connecting the sense electrodes in each column to one another, the second plurality of rows or columns being substantially perpendicular to the first plurality of rows or columns, wherein the drive and sense electrodes form an array that is configured to permit at least one location of at least one finger placed in proximity to the electrode array mounting surface to be detected using by the array.

Further embodiments are disclosed herein or will become apparent to those skilled in the art after having read and understood the specification and drawings hereof.

### BRIEF DESCRIPTION OF THE DRAWINGS

Different aspects of the various embodiments of the invention will become apparent from the following specification, drawings and claims in which:

FIG. 1 shows a prior art self-capacitance sensing system;

FIG. 2 shows a prior art mutual capacitance sensing system;

FIG. 3 shows one embodiment of a mutual capacitive sensing system 10 of the invention;

FIG. 4 shows another embodiment of a mutual capacitive sensing system 10 of the invention;

FIG. 5 illustrates the projection of electrical field lines from one embodiment of a single cell 94 of the present invention;

FIG. 6 illustrates the projection of electrical field lines from another embodiment of a single cell 94 of the present invention, which incorporates a ground conductor 63 therein;

FIG. 7 shows a cross-sectional view of a touchscreen system 10 of the prior art;

FIG. 8 shows a cross-sectional view of one embodiment of a touchscreen system 10 of the invention;

FIG. 9 shows a cross-sectional view of another embodiment of a touchscreen system 10 of the invention;

FIGS. 10 and 11 show one embodiment of single cell 94 and crossover 100 of the invention;

FIG. 12 shows another embodiment of single cell 94 and crossover 100 of the invention;

FIG. 13 shows one embodiment of a sparse electrode array 62 of the invention;

FIG. 14 shows a capacitance measurement or sensing circuit 72 according to one embodiment of the invention.

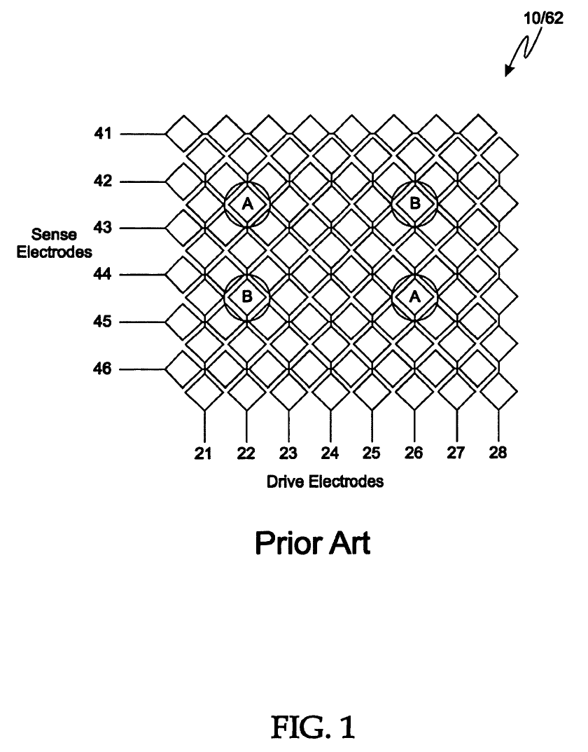

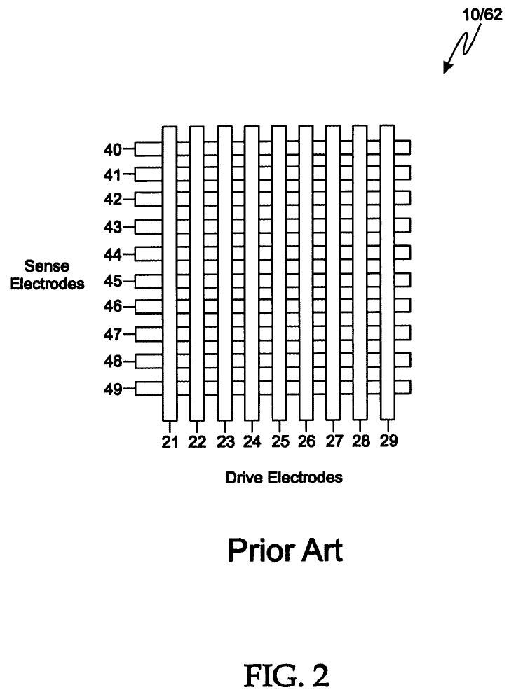

The drawings are not necessarily to scale. Like numbers refer to like parts or steps throughout the drawings.

### DETAILED DESCRIPTIONS OF SOME PREFERRED EMBODIMENTS

In the various embodiments of the invention, a mutual-capacitance system is provided having sense and drive electrodes disposed substantially in a single plane. Because sense and drive electrodes are all located in the same plane in an electrode array 62, optical attenuation occurs in only a single layer of metal or electrically conductive material such as indium-tin oxide (ITO), unlike in the prior art, where at least two such arrays or layers attenuate light, and which typically comprise ITO. In addition, in some embodiments of the invention, electrode array 62 covers the display substantially uniformly, and therefore does not cause any grid patterns to be visible on a display or screen. Since sensing measurements are based on mutual capacitance, however, a row and column sensing configuration can be employed, which reduces the pin count to only 2n for an n×n electrode grid. Furthermore, such an electrode array configuration is conducive to being arranged as interleaved fingers, which increases the ability to use interpolation techniques in determining a user's finger location, and further reduces pin count requirements in respect of prior art mutual capacitance sensing or measurement systems. Finally, relative to crossed-grid mutual capacitance systems of the prior art, the single plane electrode array configuration of the invention creates more and denser electric field lines above sensor or touch surface 104 for interaction with a user's finger, thereby enhancing the sensitivity of the system and improving noise immunity.

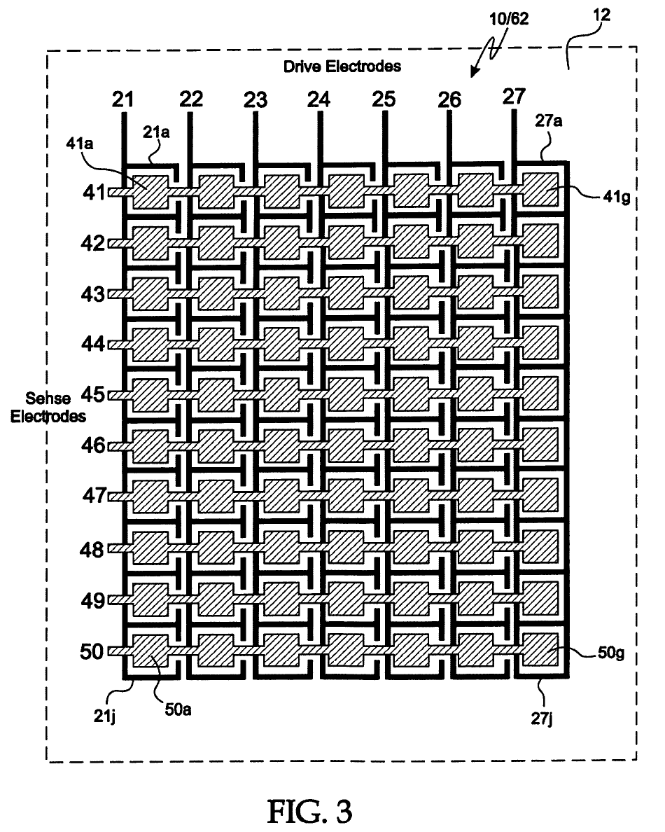

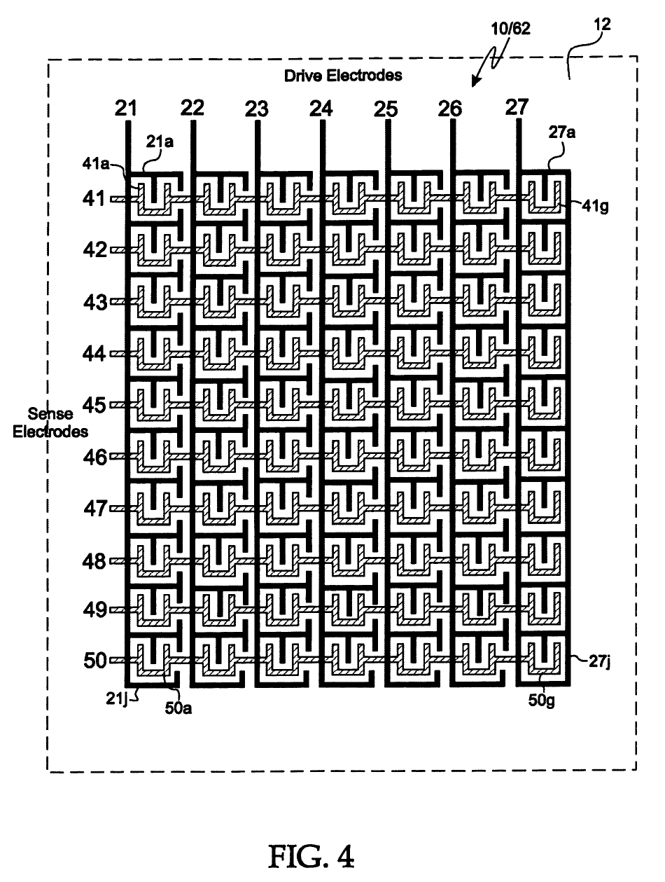

FIGS. 3 and 4 illustrate two different embodiments of mutual capacitive sensing system 10 of the invention, where array 62 is disposed upon a single substrate 12. The embodiments of system 10 illustrated in FIGS. 3 and 4 operate in accordance with the principles of mutual capacitance. Capacitances are established between individual sense and drive electrodes, e.g., electrodes 21a and 41a, electrodes 27a and 41g, electrodes 21j and 50a, and electrodes 27j and 50j by means of a drive waveform input to drive electrodes 21a through 27j. A user's finger is typically at or near electrical ground, and engages a touch surface 14 of touch layer 104 (not shown in FIGS. 3 and 4) that overlies array 62. Layer 104 is disposed between array 62 and the user's finger.

When in contact with touch surface 14, the user's finger couples to the drive signal provided by a drive electrode in closest proximity thereto and proportionately reduces the amount of capacitance between such drive electrode and its corresponding nearby sense electrode. That is, as the user's finger moves across touch surface 14, the ratio of the drive signal coupled to the respective individual sense electrodes 21a through 27j through the finger is reduced and varied, thereby providing a two-dimensional measurement of a position of the user's finger above electrode array 62.

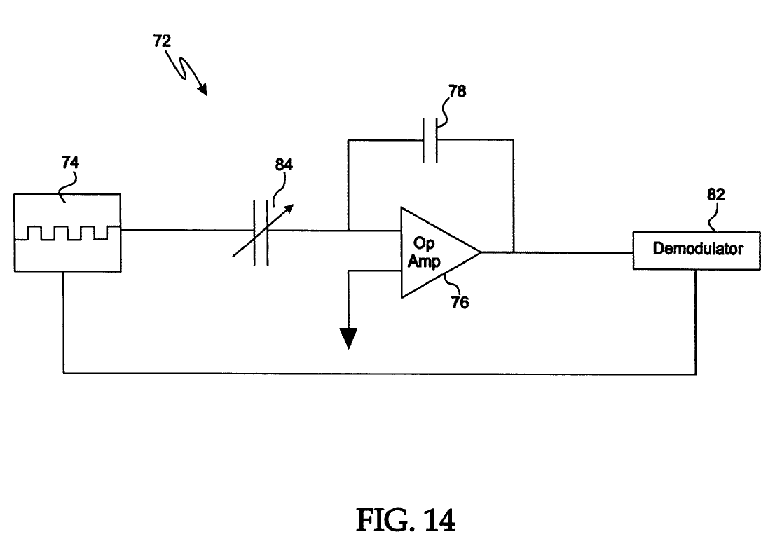

In such a manner, the capacitance at a single row-column intersection corresponding to the user's finger location is determined. By scanning all the rows and columns of array 62, a map of capacitance measurements may be created for all the nodes in the grid. Because each measurement probes only a single grid intersection point, no measurement ambiguities arise with multiple touches as in the case of some self-capacitance systems. Moreover, to measure a grid of n×n intersections, only 2n pins on an IC are required in system 10 illustrated in FIGS. 3 and 4. Thus, system 10 may be configured to scan rows 41-50 and columns 21-27 thereby to detect at least one location of the user's finger. System 10 may also be configured to multiplex signals provided by the rows and the columns to a capacitance sensing circuit 72 (see, e.g., FIG. 14).

System 10 may be configured to sense multiple touch locations in electrode array 62 substantially simultaneously. In one embodiment a host computer is updated at a rate of, for example, 60 Hz, where update rate results in fast but not altogether “simultaneous” measurements; all the rows and columns of array 62 are scanned sequentially to determine the position of any finger touches. More than one finger position can be detected at such an update rate even though technically such positions are not actually measured simultaneously.

FIG. 3 illustrates portions of mutual capacitance sensing system 10, where electrode array 62 is disposed substantially in a single layer. Sense electrodes are arranged in rows 41-50, and drive electrodes are arranged in columns 21-27 upon substrate 12, which typically comprises glass, plastic or any other suitable optically transparent material. During sensing, first column 21 is driven, and then sense measurements are taken sequentially on all of sense rows 41-50. Next, drive electrode column 22 is driven, followed by another series of sense measurements in sense electrode rows 41-50.

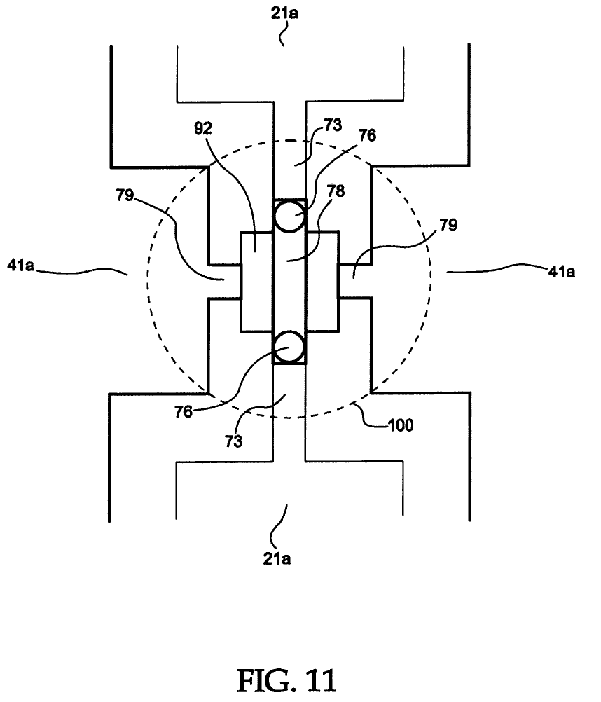

The layout of electrode array 62 shown in FIG. 3 requires seventy crossings 100 of sense drive wires (not shown in detail in FIG. 3, but more about which is said below in reference to FIGS. 11 through 13). Such crossings 100 may be physically quite small and contribute very little to sensed capacitance measurements. Crossings 100 can be configured to be small enough for fabrication using opaque electrical conductors such as metal (e.g., aluminium or gold) or may be fabricated of an at least partially optically transparent material such as ITO. Electrical connections to sense and drive electrode traces often require a second type of electrical conductor. Small opaque metal crossovers may be used for this purpose. Such crossovers may also be fabricated of ITO or another suitable at least partially optically transparent material.

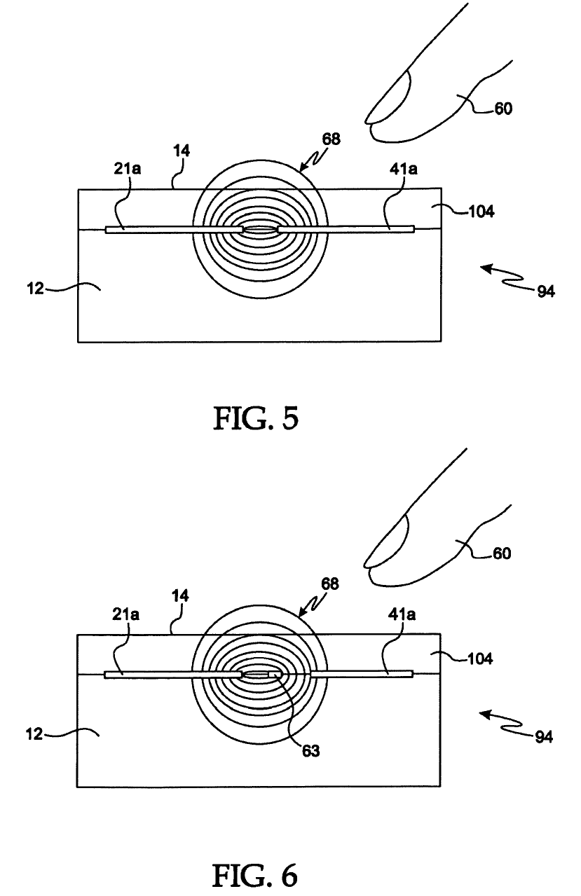

In one embodiment shown in FIGS. 5 and 6, cover glass layer 104 disposed over electrode array 62 is about 0.375 mm in thickness, and electrode array 62 provides approximately a 0.25 pF decrease in capacitance upon a user's finger being brought into proximity thereto. Note that a ground plane may also be provided beneath substrate 12, and to which portions of electrode array 62 may optionally be connected electrically.

FIG. 4 illustrates another embodiment of capacitive sensing system 10 of the invention, where electrode array 62 exhibits increased drive and sense electrode interaction and sensitivity in respect of the embodiment illustrated in FIG. 3. In the embodiment illustrated in FIG. 4, electrostatic field lines are concentrated at the borders between adjoining individual drive and sense electrodes. The overall signal produced by electrode array 62 is increased by interleaving portions of individual drive and sense electrodes 21a-27j and 41a-50g. It will now become apparent to those skilled in the art that many different electrode interleaving and electrode array configurations other than those shown or described explicitly in the drawings or specification hereof may be employed and yet fall within the scope of the invention.

In one embodiment employing the principles described above respecting FIGS. 3 and 4, the values of the individual capacitances associated with sense electrode rows 41 through 50 and drive electrode columns 21 through 27 mounted on substrate 12 are monitored or measured by capacitance sensing circuit 72 (see, e.g., FIG. 14), as are the operating states of any additional switches that might be provided in conjunction therewith. In a preferred embodiment, a 125 kHz square wave drive signal is applied to drive electrode rows 21 through 27 by capacitance sensing circuit 72 (see, e.g., FIG. 14) so that the drive signal is applied continuously to such electrode rows and the individual drive electrodes 21a through 27j forming portions thereof, although those skilled in the art will understand that other types of drive signals may be successfully employed. Indeed, the drive signal need not be supplied by capacitance sensing circuit 72, and in some embodiments is provided by a separate drive signal circuit. In a preferred embodiment, however, the drive signal circuit and the capacitance sensing circuit are incorporated into a single circuit or integrated circuit.

As shown in FIG. 6, electrode array 62 may include ground trace 63 disposed between individual drive electrode 21a and individual sense electrode 41a in a single sensing cell 94. Direct coupling of electrical field 68 between drive electrode 21a and sense electrode 41a is thereby reduced so that the majority of the coupling field lines in electrical field 68 may be interrupted by finger 60 instead of being drawn directly between electrodes 21a and 41a, an effect which may become especially pronounced in the presence of humidity or water vapor. The embodiment illustrated in FIG. 6 also blocks short strong electrical fields 68 from projecting through an overlying glass or plastic layer, thereby reducing unwanted capacitance in system 10.

FIG. 5 illustrates an embodiment of single sensing cell 94 where no such ground trace 63 is included in electrode array 62. Further details concerning the use of ground conductor 63 are to be found in U.S. patent application Ser. No. 11/945,832 to Harley entitled “Capacitive Sensing Input Device with Reduced Sensitivity to Humidity and Condensation” filed on Nov. 27, 2007, the entirety of which is hereby incorporated by reference herein.

One potential issue with a single-plane mutual capacitance electrode array 62 is that since finger 60 is an electrical conductor, finger 60 may potentially increase the mutual capacitance of system 10 by directly coupling signals between drive and sense electrodes rather than decreasing mutual capacitance through its intended action as a shunt path to ground. If system 10 operates in an environment where finger 60 is capable of equally increasing or decreasing the mutual capacitance of portions of system 10, then finger 60 would contribute no net signal change and would thereby be rendered undetectable. As long as finger 60 is sufficiently far away from electrode array 62, however, finger 60 will always act as a shunt, and the observed signal will be a decrease in overall capacitance. Accordingly, in preferred embodiments of the invention, it has been discovered that a 0.3 mm thick plastic or glass touch spacer or cover layer 104 disposed above array 62 is sufficiently thick to ensure proper operation. Other thicknesses of layer 104 disposed between finger 60 and electrode array 62 may also be employed, such as between about 0.3 mm and about 5 mm

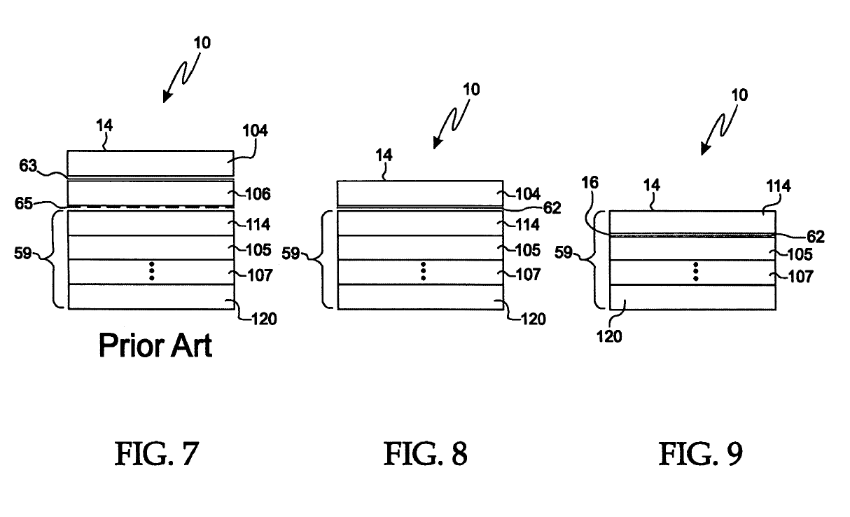

Referring now to FIGS. 7 through 9, there are shown three different embodiments of mutual capacitance systems or touchscreen devices 10. FIG. 7 shows touchscreen device 10 generally representative of a type of prior art touchscreen employed in some mobile devices. In system 10 of FIG. 7, cover glass layer 104 is disposed over indium tin oxide (ITO) rows 63 (which form a plurality of drive electrodes disposed in a plurality of rows), which are in turn are separated from ITO columns 65 (which form a plurality of sense electrodes 40 disposed in a plurality of columns 50) by touch sensor glass layer 106. Liquid Crystal Display (LCD) portion 59 of touchscreen 10 shown in FIG. 7 comprises polarizer layer 114, front glass layer 105, layer 107 (described in greater detail below), and backlighting layer 120. Thus, a capacitive sensing electrode array is formed by drive electrodes disposed in rows 63 on the upper surface of touch sensor glass layer 106 and sense electrodes disposed in columns 65 on the lower surface of touch sensor glass layer 106. In other words, and in respect of the invention described and shown herein, an extra insulating layer (106) and a second electrically conductive layer are required in the device illustrated in FIG. 7

Referring now to FIG. 8, there is shown an embodiment of the invention where touchscreen device 10 comprises cover glass layer 104 disposed over electrode array 62 comprising sense and drive electrodes disposed substantially in a single plane. Electrode array 62 overlies polarizer layer 114, which forms the top layer of LCD portion 59 of touchscreen device 10. LCD portion 59 comprises polarizer layer 114, front glass layer 105, layer 107 (described in greater detail below), and backlighting layer 120. In the embodiment illustrated in FIG. 8, the bottom surface of cover glass layer 104 forms a surface upon which array 62 may be formed, most preferably from ITO. Alternatively, electrode array 62 may be formed on the upper surface of polarizer layer 114.

FIG. 9 shows another embodiment of the invention, where touchscreen device 10 comprises polarizer layer 114 disposed over electrode array 62 comprising sense and drive electrodes disposed substantially in a single plane. Electrode array 62 underlies polarizer layer 114, which forms the top layer of LCD portion 59 of touchscreen device 10. Outer touch surface 14 is configured to permit a user a touch at least one finger 60 thereon or thereacross such that at least one location corresponding to such finger 60 may be detected by array 62. In the embodiment illustrated in FIG. 9, the bottom surface of polarizer layer 114 forms an inner surface upon which electrode array 62 may be formed. Alternatively, electrode array 62 may be formed on the upper surface of front glass layer 105. ITO is a preferred material for forming electrode array 62.

The embodiments of single layer electrode array 62 shown in FIGS. 8 and 9 eliminate altogether sensor glass and flex layer 106 of FIG. 7. Elimination of layer 106 typically results in a thickness savings of about 0.75 mm in touchscreen 10, which in a small hand-held device is significant in respect of volume, thickness and weight savings, as well as in respect of cost reduction.

Referring now to FIGS. 7, 8 and 9, polarizer layer 114 may be formed form multiple layers of plastic, adhesive and other materials. FUJI FILM™ of Japan manufactures some the individual component layers of polarizer 114, while NITKO DENKO™ (also of Japan) assembles such individual layers into final polarizer layer products. Polarizer layer 114 may then be attached by means of an intervening adhesive layer to front glass layer 105. Electrode array 62 may then be interposed between front glass layer 105 and touch glass or layer 104 (or polarizer layer 114). That is, in accordance with the teachings of the invention described and shown herein, LCD portion 59 may be adapted to yield a touchscreen LCD device that may be manufactured at only a marginally increased cost relative to LCD portions 59 of the prior art.

Note that layer 107 illustrated in FIGS. 7, 8 and 9 may comprise any of a number of materials and devices required to render LCD portion 59 operable. Such devices and materials may include (or not include, as the particular case may be), but need not be limited to, one or a plurality of a retardation film, an alignment layer, spacers, liquid crystals and/or liquid crystal cells, a reflective film, a light-scattering film, a protective layer, a color resist layer, a color filter, a glass substrate, a hard-coat material, a light guide, TFTs, an anti-reflective film, a film diffuser, a light guide plate, a transfer film, a WV film, a CV film, a ground layer, and electrical conductors or traces. Further details concerning the structure of LCD portion 59 are well known to those skilled in the art and therefore are not discussed in further detail herein.

Polarizer layer 114 may include any one or more of layers of triacetyl cellulose film (“TAC”), iodine, metal foil reflectors, protective film, polyvinyl alcohol (“PVA”), antireflection coatings, adhesives, optical retarders, glass, release film, and a grounding plane or layer. In addition, a glass layer typically included in a polarizer layer that is configured especially for use in many LCDs may serve as a substrate upon which single-plane ITO electrode array 62 of the invention may be formed. Moreover, ITO electrode array 62 of the invention may be formed on one side of front glass layer 105 (as described above) and thereby form a portion of an LCD. Such LCD structures incorporating electrode array 62 of the invention have the advantage of imparting touch sensitivity to LCDs while minimally increasing cost or thickness.

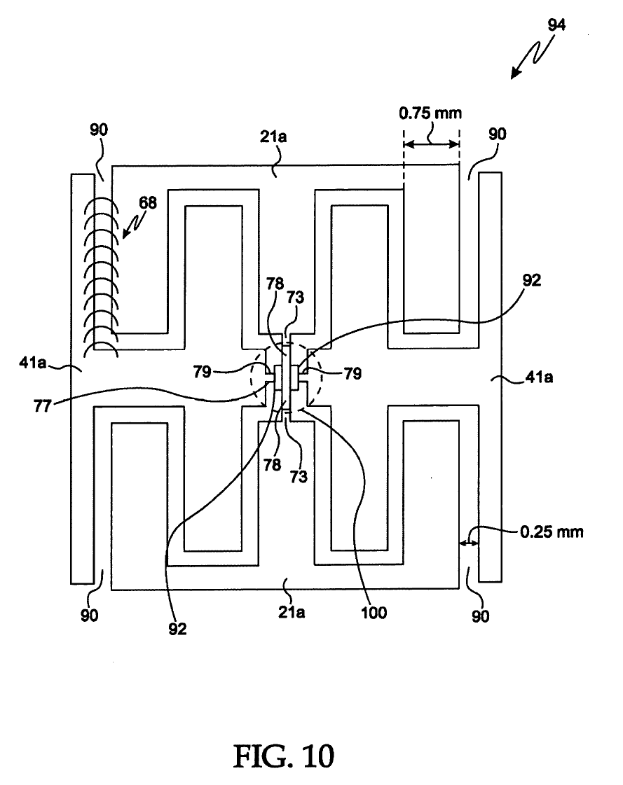

Referring now to FIGS. 10 through 12, there are shown two different embodiments of crossover 100, which permits sense and drive electrodes 41a and 21a, respectively, to be disposed substantially within a single plane atop substrate 12. FIGS. 10 and 11 show one such embodiment, where top and bottom portions of drive electrodes 21a are electrically connected by electrical connections 76 and connecting trace 78. Left and right portions of sensing electrodes 41a are electrically connected to one another by connecting trace 79. Connecting traces 78 and 79 are separated from one another by dielectric electrically insulating layer 92, which is preferably formed of silicon. Drive and sense electrodes are preferably formed of ITO, while connecting traces 78 and 79 and electrical connections 76 may be formed of any suitable metal, such as copper, tungsten, aluminium, gold, a suitable alloy or other suitable metals, alloys or electrically conductive materials such as ITO. As shown in FIGS. 10 and 11, interleaved drive electrode arms are about 0.75 mm in width, while gap 90 is about 0.25 mm in width. Capacitive electric field coupling between sense electrode 41a and drive electrode 21a is illustrated schematically by electric field lines 68 in FIG. 10. FIG. 11 shows crossover 100 of FIG. 11 in greater detail.

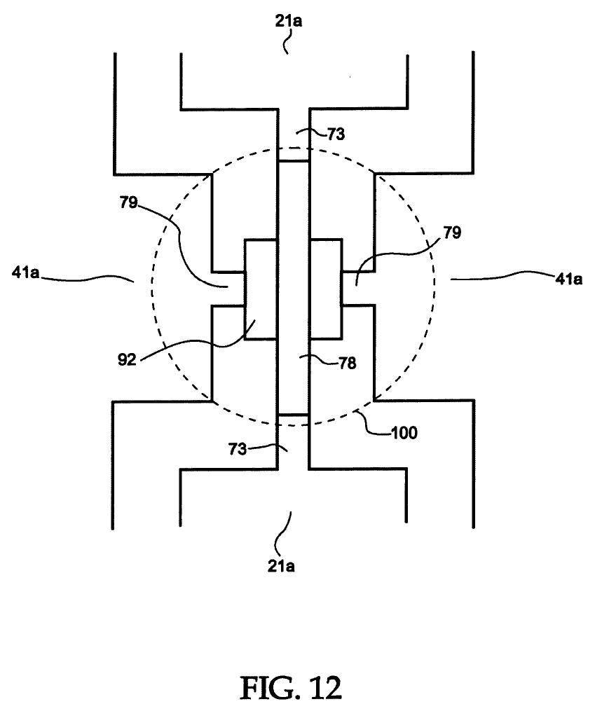

FIG. 12 shows another embodiment of crossover 100, where top and bottom portions of drive electrodes 21a are electrically connected by connecting trace 78 and no vias are employed. Left and right portions of sensing electrodes 41a are electrically connected to one another by connecting trace 79. Connecting traces 78 and 79 are separated by dielectric insulating layer 92, which is preferably formed of silicon. Drive and sense electrodes are formed of ITO, and connecting trace 78 may be formed of any suitable metal, such as copper, tungsten, aluminium, gold or any other suitable metal, metal alloy or other electrically conductive material such as ITO.

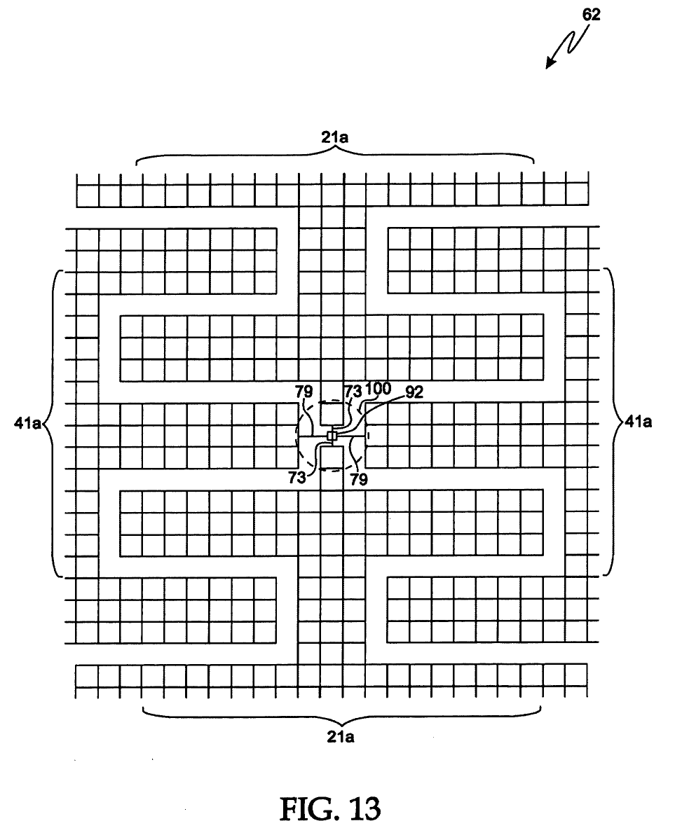

FIG. 13 shows another embodiment of electrode array 62 and crossover 100, where electrode array 62 forms a pattern of sparse electrodes or relatively thin electrically conductive traces disposed on substrate 12. In the sparse electrode embodiment of array 62 illustrated in FIG. 13, sense and drive electrodes 21a and 41a do not form rectangular or other areal patterns configured to spread out areally from electrically conductive traces or lines to increase the surface area thereof, and which are filled with ITO or another suitable electrically conductive material, so as to provide adequate sensing or measuring sensitivity. Instead, it has been discovered that nearly as much, or even substantially the same, measuring or sensing sensitivity may be provided by an electrode array pattern similar to that of FIG. 13, where a non-filled mesh of electrically conductive traces or lines is provided. In the embodiment illustrated in FIG. 13, and by way of example only, individual electrode lines or traces may be spaced from one another by about 0.25 micrometers and be disposed on substrate 12 on a 250 micrometer pitch. Such a trace configuration consumes only about 10% of the area of substrate, and thus correspondingly increases optical transmissivity in respect of the embodiments of filled electrode arrays 62 illustrated in FIGS. 3, 4, 10, 11 and 12. Note that electrode arrays 62 of the invention employing a mesh electrode configuration may also be configured to have optical transmissivities greater than that of array 62 shown in FIG. 13.

FIG. 14 shows one embodiment of a circuit diagram for capacitive sensing or measurement system 10 of the invention. By way of example, an AVAGO™ AMRI-2000 integrated circuit may be employed to perform the functions of capacitance sensing circuit 72. A low-impedance AC waveform (e.g., a 100 kHz square wave) is provided to a drive electrode 21 (not shown in FIG. 15) by signal generator 74. Operational amplifier 76 with feedback capacitor 78 is connected to a sense electrode, and holds the sense line at virtual ground. Amplifier 76 acts as a charge to voltage converter, providing a voltage measurement of the charge induced through capacitor 78. Subsequent filtering or synchronous demodulation is effected by demodulator 82 and used to extract low-frequency information from the generated AC signal. Variable capacitor 84 indicates the mutual capacitance between drive sense electrodes, as modulated by the presence of finger 60 (not shown in FIG. 15). Feedback capacitor 78 sets the gain of system 10. Those skilled in the art will appreciate that many circuits other than that shown in FIG. 15 may be employed to drive and sense electrode array 62 of the invention. One example of an integrated circuit that may be adapted to drive and sense signals provided by electrode array 62 is an AVAGO™ AMRI-2000 integrated circuit.

Output signals provided by electrode array 62 and circuit 72 are preferably routed to a host processor via, for example, a serial I²C-compatible or Serial Peripheral Interface (SPI) bus. For example, an AVAGO™ AMRI-2000 integrated circuit may be programmed to provide output signals to a host processor via such busses. The host processor may use information provided by the AMRI-2000 integrated circuit to control a display.

It will now become apparent to those skilled in the art that the various embodiments of the invention disclosed herein provide several advantages, including, but not limited to: (a) permitting single sided patterning in touchscreen, touchpad and LCD devices, which reduces costs and permits the use of only a single flex connector to establish electrical connection with ITO array 62; (b) eliminating at least one layer of glass in touchscreen, touchpad and LCD devices, which permits thinner devices to be manufactured; (c) projecting electric field lines in a more focused fashion, and with increased field density, from electrode array 62, which permits devices with increased sensitivity to be provided; (d) permitting devices with minimal electrode array routing outside the visible area of a touchscreen, touchpad or LCD to be manufactured, which may be employed to provide a small footprint for such devices; (e) permitting “simultaneous” multi-touch measurements to be made accurately and reliably and consistently on a touchscreen, touchpad or LCD device.

While the primary use of capacitive sensing or measurement system 10 of the present invention is believed likely to be in the context of relatively small portable devices, and touchpads or touchscreens therefore, it may also be of value in the context of larger devices, including, for example, keyboards associated with desktop computers or other less portable devices such as exercise equipment, industrial control panels, washing machines and the like. Similarly, while many embodiments of the invention are believed most likely to be configured for manipulation by a user's fingers, some embodiments may also be configured for manipulation by other mechanisms or body parts. For example, the invention might be located on or in the hand rest of a keyboard and engaged by the heel of the user's hand. Furthermore, the invention is not limited in scope to drive electrodes disposed in columns and sense electrodes disposed in rows. Instead, rows and columns are interchangeable in respect of sense and drive electrodes.

Note further that included within the scope of the present invention are methods of making and having made the various components, devices and systems described herein.

The above-described embodiments should be considered as examples of the present invention, rather than as limiting the scope of the invention. In addition to the foregoing embodiments of the invention, review of the detailed description and accompanying drawings will show that there are other embodiments of the present invention. Accordingly, many combinations, permutations, variations and modifications of the foregoing embodiments of the present invention not set forth explicitly herein will nevertheless fall within the scope of the present invention.

We claim:

1. A mutual capacitance sensing system, comprising:
at least one substrate comprising an outer touch surface and an inner surface disposed substantially in a single plane, the outer touch and inner surfaces forming opposing substantially planar and substantially parallel surfaces;
a plurality of drive electrodes disposed in a first plurality of rows or columns positioned upon the inner surface substantially in the single plane, the drive electrodes in each row or column being electrically connected to one another;
a plurality of sense electrodes disposed in a second plurality of rows or columns also positioned upon the inner surface substantially in the single plane, the sense electrodes in each column being electrically connected to one another;
wherein the first plurality of rows or columns is substantially perpendicular to the second plurality of rows or columns, the outer touch surface is configured for a user to place at least one finger thereon and move the at least one finger thereacross, and the drive and sense electrodes form an array configured in respect of the outer touch surface to permit at least one location corresponding to the at least one finger on the outer touch surface to be detected by the array.

2. The mutual capacitance touchscreen of claim 1, wherein the plurality of drive electrodes in each row are interleaved with corresponding sense electrodes intersecting therewith.

3. The mutual capacitance touchscreen of claim 1, wherein the plurality of sense electrodes in each column are interleaved with corresponding drive electrodes intersecting therewith.

4. The mutual capacitance sensing system of claim 1, wherein at least one of the plurality of drive electrodes and the plurality of sense electrodes comprises indium tin oxide (ITO).

5. The mutual capacitance sensing system of claim 1, wherein the substrate comprises at least one of glass and plastic.

6. The mutual capacitance sensing system of claim 1, wherein the substrate is substantially optically transparent.

7. The mutual capacitance sensing system of claim 1, further comprising a ground layer disposed beneath the inner surface of the substrate.

8. The mutual capacitance sensing system of claim 1, wherein at least one electrically conductive fixed potential or ground conductor is disposed between at least portions of the plurality of drive electrodes and the plurality of sense electrodes.

9. The mutual capacitance sensing system of claim 1, further comprising a drive signal circuit configured to provide an electrical drive signal to the plurality of drive electrodes and operably connected thereto.

10. The mutual capacitance sensing system of claim 1, further comprising a capacitance sensing circuit operably coupled to the plurality of sense electrodes and configured to detect changes in capacitance occurring therein or thereabout.

11. The mutual capacitance sensing system of claim 1, wherein at least one of the drive signal circuit and the capacitance sensing circuit is incorporated into an integrated circuit.

12. The mutual capacitance sensing system of claim 1, further comprising at least one polarizer layer.

13. The mutual capacitance sensing system of claim 1, wherein the polarizer layer comprises polyvinylalcohol (PVA).

14. The mutual capacitance sensing system of claim 1, further comprising at least one of a triacetyl cellulose (TAC) film layer, a glue layer, an optical retarder layer and a backlighting layer.

15. The mutual capacitance sensing system of claim 1, wherein the system is incorporated into or forms a portion of an LCD, a computer display, a laptop computer, a personal data assistant (PDA), a mobile telephone, a radio, an MP3 player, a portable music player, a stationary device, a television, a stereo, an exercise machine, an industrial control, a control panel, an outdoor control device and a washing machine.

16. The mutual capacitance sensing system of claim 1, wherein the system forms a portion of a touchscreen or a touchpad.

17. The mutual capacitance sensing system of claim 1, wherein the system is configured to scan the first and second pluralities of rows and columns thereby to detect the at least one location.

18. The mutual capacitance sensing system of claim 1, wherein the system is configured to multiplex signals provided by at least one of the first and second pluralities of rows and the columns.

19. The mutual capacitance sensing system of claim 1, wherein the system is configured to sense multiple locations in the array simultaneously.

20. A mutual capacitance sensing system, comprising:
at least one substrate comprising an electrode array mounting surface disposed substantially in the single plane;
a plurality of drive electrodes disposed in a first plurality of rows or columns positioned upon the electrode array mounting surface substantially in the single plane, the drive electrodes in each row being electrically connected to one another;
a plurality of sense electrodes disposed in a second plurality of rows or columns positioned upon the electrode array mounting surface substantially in the single plane, the sense electrodes in each column being electrically connected to one another;
wherein the first plurality of rows or columns is substantially perpendicular to the second plurality of rows or columns, and the drive and sense electrodes form an array configured to permit at least one location corresponding to at least one finger placed in proximity to the electrode array mounting surface to be detected by the array.

21. The mutual capacitance sensing system of claim 20, wherein an electrically insulative touch layer is disposed over the electrode array mounting surface.

22. The mutual capacitance sensing system of claim 20, wherein the electrically insulative touch layer comprises glass or plastic.

23. The mutual capacitance sensing system of claim 20, wherein the plurality of drive electrodes in each row are interleaved with corresponding sense electrodes intersecting therewith.

24. The mutual capacitance sensing system of claim 20, wherein the plurality of sense electrodes in each column are interleaved with corresponding drive electrodes intersecting therewith.

25. The mutual capacitance sensing system of claim 20, wherein at least one of the plurality of drive electrodes and the plurality of sense electrodes comprises indium tin oxide (ITO).

26. The mutual capacitance sensing system of claim 20, wherein the substrate comprises at least one of glass and plastic.

27. The mutual capacitance sensing system of claim 20, wherein the substrate is substantially optically transparent.

28. The mutual capacitance sensing system of claim 20, further comprising a ground layer.

29. The mutual capacitance sensing system of claim 20, wherein at least one electrically conductive fixed potential or ground conductor is disposed between at least portions of the plurality of drive electrodes and the plurality of sense electrodes.

30. The mutual capacitance sensing system of claim 20, further comprising a drive signal circuit configured to provide an electrical drive signal to the plurality of drive electrodes and operably connected thereto.

31. The mutual capacitance sensing system of claim 20, further comprising a capacitance sensing circuit operably coupled to the plurality of sense electrodes and configured to detect changes in capacitance occurring therein or thereabout.

32. The mutual capacitance sensing system of claim 20, wherein at least one of the drive signal circuit and the capacitance sensing circuit is incorporated into an integrated circuit.

33. The mutual capacitance sensing system of claim 20, further comprising at least one polarizer layer.

34. The mutual capacitance sensing system of claim 33, wherein the polarizer layer comprises polyvinylalcohol (PVA).

35. The mutual capacitance sensing system of claim 16, further comprising at least one of a triacetyl cellulose (TAC) film layer, a glue layer, an optical retarder layer and a backlighting layer.

36. The mutual capacitance sensing system of claim 20, wherein the system is incorporated into or forms a portion of an LCD, a computer display, a laptop computer, a personal data assistant (PDA), a mobile telephone, a radio, an MP3 player, a portable music player, a stationary device, a television, a stereo, an exercise machine, an industrial control, a control panel, an outdoor control device and a washing machine.

37. The mutual capacitance sensing system of claim 20, wherein the system is configured to scan the first and second pluralities of rows and columns thereby to detect the at least one location.

38. The mutual capacitance sensing system of claim 20, wherein the system is configured to multiplex signals provided by at least one of the first and second pluralities of rows and columns.

39. The mutual capacitance sensing system of claim 20, wherein the system is configured to sense multiple locations in the array simultaneously.

40. A method of making a mutual capacitance sensing system, comprising:
providing at least one substrate comprising an outer touch surface and an inner surface disposed in a single plane, the outer touch and inner surfaces forming opposing substantially planar and substantially parallel surfaces;
disposing a plurality of drive electrodes in a first plurality of rows or columns upon the inner surface substantially in the single plane, and electrically connecting the drive electrodes in each row or column to one another, and
disposing a plurality of sense electrodes in a second plurality of rows or columns upon the inner surface substantially in the single plane and electrically connecting the sense electrodes in each row or column, the second plurality of rows or columns being substantially perpendicular to the first plurality of rows or columns;
wherein the drive and sense electrodes form an array that is configured to permit at least one location corresponding to at least one finger placed on the outer touch surface to be detected by the array.

41. A method of making a mutual capacitance sensing system, comprising:
providing at least one substrate comprising an electrode array mounting surface disposed in a single plane;
disposing a plurality of drive electrodes in a first plurality of rows or columns upon the electrode array mounting surface substantially in the single plane, and electrically connecting the drive electrodes in each row or column to one another;
disposing a plurality of sense electrodes in a second plurality of rows or columns upon the electrode array mounting surface substantially in the single plane, and electrically connecting the sense electrodes in each column to one another, the second plurality of rows or columns being substantially perpendicular to the first plurality of rows or columns;
wherein the drive and sense electrodes form an array that is configured to permit at least one location of at least one finger placed in proximity to the electrode array mounting surface to be detected using by the array.
